(19) United States
(12) Patent Application Publication
(10) Pub. No.: US 2012/0247966 A1
(43) Pub. Date: Oct. 4, 2012

(54) METHOD FOR ELECTROCHEMICAL COATING OF A SUBSTRATE BY MEANS OF BRUSH PLATING AND DEVICE FOR CARRYING OUT SAID METHOD

(76) Inventors: Axel Arndt, Berlin (DE); Jens Dahl Jensen, Berlin (DE); Ursus Krüger, Berlin (DE); Stefan Lechner, Leonding (AT); Marinko Lekic-Ninic, Etmissl (AT); Uwe Pyritz, Berlin (DE); Manuela Schneider, Berlin (DE); Heike Springborn, Berlin (DE); Peter Wieser, Linz (AT)

(21) Appl. No.: 13/499,398

(22) PCT Filed: Aug. 26, 2010
(86) PCT No.: PCT/EP2010/062501

§ 371 Date: Jun. 11, 2012

(30) Foreign Application Priority Data
Sep. 30, 2009 (DE) 102009048669.0

(51) Int. Cl. C25D 15/00; C25D 17/00; B82Y 99/00

(52) U.S. Cl. 205/109; 204/275.1; 977/742; 977/700

(57) ABSTRACT

A method electrochemically coats a substrate by brush plating. Particles are applied to the surface to be coated via a separated line system before the carrier for the electrolytes. The electrolyte is added to the carrier via a line system. The advantageous result thereof is that an agglomeration of the particles can be prevented because only a short time passes after the application of the particles until the formation of the layer. A device for electrochemical coating has two line systems for the cited purpose. The highly stressed surface components of rollers in rolling mills can be partially coated by the method.

### CROSS REFERENCE TO RELATED APPLICATIONS

This application is based on and hereby claims priority to International Application No. PCT/EP2010/062501 filed on Aug. 26, 2010 and German Application No. 10 2009 048 669.0 filed on Sep. 30, 2009, the contents of which are hereby incorporated by reference.

### BACKGROUND

A process for incorporating particles into a layer can be gathered, for example, from DE 101 25 290 A1, DE 101 25 289 A1 or JP 01301897 A. The last-mentioned document proposes the use of a brush plating process for producing a layer in which particles are dispersed. Brush plating is to be understood as meaning an electrochemical coating process in which the substrate to be coated is not dipped into an electrolyte, but instead the electrolyte is applied to the substrate using a carrier referred to as a brush. More specifically, a brush does not have to be used in this process. Instead, the carrier has to have the properties which make it capable of transferring the electrolyte onto the substrate owing to superior capillary forces. By way of example, a brush is suitable for this purpose because capillary channels suitable for transporting the electrolyte are formed between the individual bristles. Examples of other structures suitable for transferring the electrolyte are sponge-like, i.e. open-pored, inherently elastic materials.

In order to make effective coating possible, the carrier is fed with electrolyte through a channel system, which is fluidically connected to the capillary channels of the carrier. Compared to conventional electrochemical coating, in which the substrate is dipped into the electrolyte, the significant advantage is that a high material throughput is made possible by the continuous feed of electrolyte. During electroplating, for example, correspondingly high deposition currents can accordingly be implemented, and rapid layer build-up is thereby possible. In contrast to electrolyte baths, the continuous flow of the electrolyte in brush plating makes it possible to prevent the establishment of a steady state, which limits the coating rate, in the electrolyte owing to a limited diffusion rate.

It goes without saying that it is also known to incorporate particles in electrochemically produced layers which have been coated in an electrochemical bath. By way of example, it is known according to US 2007/0036978 A1 to incorporate CNTs (this abbreviation is used hereinbelow for carbon nanotubes) in electrochemically deposited layers. Analogously, it was also possible to incorporate BNNTs (this abbreviation is used hereinbelow for boron nitride nanotubes). However, a factor which further limits the incorporation of the CNTs in this case is the fact that said CNTs can only be dispersed in the electrochemical bath to a limited extent. The production of stable dispersions, i.e. dispersions which also remain stable for a relatively long period of time of more than 24 hours, creates problems. Although it is possible to stabilize the dispersion by using wetting agents, the latter are then also deposited at least partially in the layers. However, an improvement in the conductivity is sought, for example, with the incorporation of CNTs in electrochemical layers. However, the presence of wetting agents, which primarily remain on the surface of the CNTs, restricts the desired effect of the incorporation of CNTs in the metallic matrix of the electrochemically deposited layer.

Finally, DE 10 2004 030 523 A1 discloses a powder conveyor.

### SUMMARY

It is one possible object of the invention, therefore, to specify a process for the electrochemical coating of substrates by brush plating, in which process a relatively high margin is made available for the incorporation of particles.

The inventors propose a process in which the carrier is fed via a first conduit system for the electrolyte, in which the concentration of particles is at least reduced compared to the required concentration for sufficient incorporation, or no particles are present. In addition, a second conduit system for the particles is provided, with which particles are applied directly to the substrate to be coated before treatment with the carrier. The process has the advantageous effect that no stable dispersion of particles has to be produced in the electrolyte. Instead, use is made of the fact that the time for the layer formation process is very short in brush plating. The particles are advantageously applied with the separate feed, the second conduit system, directly before coating by brush plating (more details are given hereinbelow concerning the specific configuration of the second conduit system). Therefore, undesirable agglomeration of particles during the short time until the substrate is coated is precluded. This has the advantage that it is also possible to use particles such as CNTs or BNNTs, which are poorly dispersible per se in the available electrolyte. Another possibility for making meaningful use of this fact relates to in the fact that it is possible to apply the particles in relatively high concentrations, which are normally no longer stable as a dispersion in the electrolyte in question. This makes it possible to increase the rate of incorporation of particles in the layer which forms. The process window available for forming electrochemical layers with dispersed particles is therefore advantageously larger.

A further advantage of brush plating arises from the fact that the transfer medium is in contact with the substrate during the layer formation process. This counteracts dendritic layer growth, since the layer which forms is compacted immediately. Specifically, the introduction of CNTs would otherwise promote the formation of dendrites—with negative effects on the quality of the layer.

According to another configuration, the particles are supplied in the second conduit system as a dispersion. The dispersing agent used in this case may equally be a gas (formation of an aerosol) or a liquid (formation of a suspension). However, it is also possible to convey and meter the particles to be incorporated in the layer to be formed as a powder. However, the use of dispersions has the advantage that handling is generally simplified. The electrolyte itself is preferably also used as the liquid dispersing agent. The electrolyte fed in through the first conduit system and the electrolyte fed in through the second conduit system therefore merely differ in terms of the concentration of dispersed particles. The electrolyte in the first conduit system, which makes up the majority of the throughput, is advantageously not provided with a relatively large quantity of particles in this case, such that handling is advantageously simplified. Particularly if the electrolyte is used repeatedly, i.e. the electrolyte is collected after brush plating has taken place and returned into the supply unit from which the first conduit system is fed, it may be the case, however, that small quantities of particles are present in said electrolyte. However, these do not bring about the problems of agglomeration mentioned above since, if a critical concentration is reached, the particles already precipitate in the collection container after brush plating has taken place and are therefore not returned into the supply container.

On the other hand, the relatively small quantity of electrolyte or other dispersion applied by the second conduit system can be mixed in each case briefly before it is used, and therefore long-term stability of this suspension is not required. Alternatively, the liquid dispersing agent used can also be a liquid in which it is easier to disperse the relevant particles. However, this dispersing agent must not have an undesirable influence on the subsequent coating process of the brush plating. This has to be taken into consideration accordingly when selecting the dispersing agent.

If a liquid is supplied as the dispersing agent, these can advantageously be selected such that the dispersing agent evaporates or sublimates at the temperatures which prevail during the brush plating. It is thereby withdrawn from the brush plating process before it can be incorporated in the coating which forms. It may be necessary to ensure that there is a suitable collecting device, which prevents the gaseous dispersing agent from escaping into the surroundings. This makes it possible to avoid any possible risks to health and for the dispersing agent to be used for renewed dispersion formation.

According to another configuration of the process, agglomeration of the particles is prevented by the action of an energy, in particular ultrasound, in the second conduit system. Supercritical dispersions can thereby advantageously also be used, since the risk of the dispersed particles already agglomerating in the second conduit system can be reduced by the introduction of energy.

A further advantageous configuration is obtained if the particles are nanoparticles, in particular CNTs and/or BNNTs. If nanoparticles are used, it is advantageously possible to produce particularly fine layer structures on the component to be coated. In addition, the above-mentioned mechanisms for preventing the agglomeration of nanoparticles before they are incorporated in the layer can be utilized particularly effectively. In particular, the incorporation of CNTs in a metallic matrix without the use of wetting agents, which disrupt the function of the coating, is advantageously made possible.

According to another advantageous configuration, the carrier is guided over the substrate in a direction in which the CNTs and/or BNNTs are to be oriented with preference in the layer which forms. Specifically, it has surprisingly been found that particles applied before the brush plating are aligned outstandingly in the direction of movement of the carrier, by subsequently passing the carrier over them, if said particles have an elongate form, like CNTs or BNNTs. The preferred orientation of the CNTs and/or BNNTs advantageously makes it possible to purposefully equip the layer produced with anisotropic properties, for example in respect of the strength thereof or the electrical conductivity thereof. In particular, it is also possible to generate various orientations of the CNTs and/or BNNTs if a plurality of plies are provided. To this end, the carrier merely has to be moved in the various desired orientations, with each ply being produced with one of the desired orientations. By way of example, it is possible to rotate the substrate, after one ply has been produced, by in each case 90° in relation to the next ply, so as to produce a type of CNT lattice or BNNT lattice.

It is particularly advantageous if the substrate coated is a roller, which is rotated below the carrier after the latter has been positioned. By simply rotating the roller, it is advantageously possible to achieve a relative movement between the substrate and the carrier, thus making uniform coating of the roller possible. In particular, by rotating the roller it is possible for the described preferred orientation of CNTs and/or BNNTs to be effected in the circumferential direction of the roller. This has the advantage, for example for an increase in strength by the coating, that the latter is effected in the circumferential direction.

Furthermore, it can advantageously be provided that, during the coating of the roller-shaped substrate, in addition to the rotation of the substrate about the center axis thereof, a linear relative movement is executed in the direction of the axis of rotation between the carrier and the substrate. This is particularly advantageous if the roller to be coated has a particularly large form. It is then not necessary to use a carrier which extends over the entire length of the roller, but instead the simultaneous linear relative movement in the direction of the axis of rotation and the simultaneous rotation of the roller mean that a helical coating path is covered on the roller, which ultimately leads to the coating of the entire roller.

According to another configuration, the particles are applied to the substrate by the second conduit system only in partial regions of the layer to be produced, or the applied quantity of particles is varied locally in the region of the layer to be applied. As a result, the layer can advantageously be locally adapted to a specific requirement profile. By way of example, it is conceivable to provide the running surfaces of a plain bearing on the surface of a roller with particles which ensure increased wear protection there. It is also conceivable to locally adapt the conductivity of the coating to the required values, in order to provide the layer with an electrical guide with a significantly reduced electrical resistance. Said design freedom for the structure of the layer is achieved by the second conduit system applying particles before the brush plating only in those partial regions where said particles are to be incorporated in the layer. Other regions are then coated by the brush plating without the incorporation of particles.

A particular configuration provides that the layer is produced electrochemically in a plurality of plies, wherein particles are applied to the surface to be coated via the second conduit system before the application of each ply by brush plating. As a result, it is advantageously possible to also produce layers with a relatively large thickness in which particles are distributed. By way of example, it is possible to coat working rollers of rolling mills, which, on account of the high mechanical loading thereof, are subject to a high degree of wear. In order to increase the service life of the working rollers, particles of a hard material can advantageously be incorporated in the coating. With progressive abrasion of the layer, new particles are then always exposed on the current surface, in which case the particles themselves advantageously not only reduce the wear, but also always provide for a certain surface roughness with progressive abrasion of the layer, since said particles, on account of the relatively low material removal therefrom and possibly on account of break-out from the layer surface, lead to a rugged surface of the layer. The high surface roughness is required specifically for working rollers in cold rolling so that the torque of the working roller can be transferred to the material to be rolled (for example sheet metal). Metal carbides such as SiC, TiC and WC, metal nitrides such as TiN, SiN and BN and metal oxides such as Al₂O₃, SiO₂ and TiO₂ are suitable as preferred hard materials for incorporation in the layer. With further preference, particles of hard metals which form metallic hard phases in the layer can be incorporated. Suitable hard metals are particles having a proportion of 90 to 94% by weight WC, TiC or TiN in a Co, Ni or Mo matrix. The incorporation of said hard metal particles in the layer leads to a concentration of up to 50% by volume, preferably to a concentration of 10 to 15% by volume, of hard metal particles in the electrochemically deposited layer.

By repeating the brush plating a number of times, it is also possible to produce so-called multilayer or gradient layers. The individual plies, which are deposited electrochemically, can turn out to be thicker or thinner, depending on the required concentration of particles. In the case of said example relating to the working rollers for rolling mills, it is necessary that the individual plies produced by the brush plating are not significantly thicker than the diameter of the incorporated particles. Only in this way can it be ensured that particles are always exposed on the layer surface as a result of progressive removal of the layer produced. A multilayer layer can be produced by virtue of the fact that, after one or more plies, the concentration of the incorporated particles is varied or different particles are incorporated in the individual plies. A gradient layer can be produced by successively varying the concentration of one type or more types of particles from ply to ply. In this case, the individual plies are produced to be so thin that a gradual concentration gradient, without leaps in the concentration, is formed over the layer thickness.

The individual plies can be produced in various ways. By way of example, the carrier can be moved to and fro on the surface to be coated. In this case, the particles can be supplied alternately upstream and downstream of the carrier, but in each case upstream of the carrier in the direction of movement. To this end, two different conveying systems for the particles can be provided. Alternatively, it is also possible for in each case one ply of the layer to be produced without particles and one ply to be produced with the particles, in which case, for the ply with the particles, that direction of movement is always chosen in the case of which the influx of particles to be incorporated is possible upstream of the carrier, as seen in the direction of movement.

Furthermore, it is also possible to provide a plurality of carriers each with a second conduit system, which are arranged in succession. It is thereby possible, particularly in the case of strip coating, to achieve a relatively quick layer growth, and this is why this solution can be used particularly efficiently. At the same time, the use of a plurality of carriers can make it possible to produce plies with different particles or layer materials.

Furthermore, the inventors propose to a device for the electrochemical coating of substrates by brush plating, comprising a carrier, through which liquid can pass and which has a transfer surface, for applying an electrolyte to a substrate to be coated, and a first conduit system for the electrolyte, which has outlets on the carrier.

A device of this type is described in JP 01301897 A, which has already been mentioned in the introduction. According to this document, the device for brush plating has a roller-shaped design, a sponge-like roller being used as the carrier. The interior of this roller is provided with the conduit system, which has the form of an elongate cylinder running in the center of the carrier. This tubular conduit system has a plurality of bores, which issue into the material of the carrier.

Another potential object is to specify a device for the electrochemical coating of a substrate by brush plating, by which device it is possible to produce electrochemical layers, in which particles are dispersed, relatively effectively.

The inventors propose that the device has a second conduit system, which can be fed independently of the first conduit system and which has an issue point arranged upstream of the transfer surface.

The method and device thereby provide a possible way of supplying the particles to be incorporated in the coating to be formed separately to the device. It is thereby possible to apply the particles to be incorporated in the coating to the surface of the substrate to be coated only just before the coating operation is carried out. For this purpose, the issue point of the second conduit system, as already mentioned, has to be arranged upstream of the transfer surface. This means that the particles can be applied beforehand as seen in the direction of the relative movement between the carrier with the transfer surface and the substrate to be coated. This means that the second conduit system with the issue point is routed upstream of the transfer surface of the carrier. It is preferable that said system can also be structurally combined in the device to form a subassembly.

The issue point of the second conduit system has to be formed in such a manner that the desired process for applying the particles can be implemented. If, for example (and preferably), the particles are dispersed in a liquid, the latter can be applied by spraying. In this case, the issue point has to be in the form of a spray nozzle. Another possibility is to provide the nozzle in the form of a pipette, such that the suspension can be dripped on. By a nozzle, it is also possible for the particles to be dispersed in a gas, in which case the adhesive forces of the particles are utilized upon impact on the substrate. The flow rates which are achieved therefore have to be appropriately small, so that sufficient time remains for the particles to adhere. It goes without saying that it is also possible to equip the issue point with a separate carrier, which implements the same operating principle as the carrier of the electrolyte. The capillary channels made available by the carrier can then be used to supply a preferred liquid dispersion to the surface. It is also possible to use the same carrier for transferring the electrolyte and for transferring the particle dispersion, in which case the issue point of the second conduit system lies upstream of the first conduit system, as seen in the direction of movement.

As a result of supplying the particles in the second conduit system, it is advantageously possible to avoid the production of a dispersion formed of the coating electrolyte and the particles to be incorporated. This makes it possible to incorporate particularly particles whose dispersion in the electrolyte as the dispersing agent is problematic in the electrochemically forming layer. By way of example, the use of wetting agents, which can have a negative influence on the layer result, can also be avoided, as already mentioned.

According to one configuration, the second conduit system engages with a generator for ultrasound. The generator engages with the second conduit system by virtue of the fact that the ultrasound produced by the generator acts at least in the second conduit system. The ultrasound has the advantageous effect that particles conveyed in the second conduit system do not agglomerate. By way of example, a powder of particles conveyed in the second conduit system can also be kept in fluid form by the ultrasound. More precise details relating to how the ultrasound generator can be applied in the conduit system can be gathered, for example, from DE 10 2004 030 523 A1.

Additionally, it is advantageous if the issue points of the second conduit system are provided with metering valves, in particular piezo valves. This configuration, too, can be implemented by taking the details from DE 10 2004 030 523 A1, mentioned above, into consideration. Very precise metering of the particles for application to the substrate is advantageously possible owing to the use of the piezo valves, even if said particles are handled in the form of a powder.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 schematically shows the course of an exemplary embodiment of the proposed process using an exemplary embodiment of the proposed device,

FIG. 2 is a cross-sectional view of a conduit module, as can be used in another exemplary embodiment of the proposed device,

FIGS. 3 and 4 show exemplary embodiments of the process, in which a working roller for a rolling mill or another roller is coated.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

A device 11 has a carrier 12 and a conduit module 13, to which the carrier 12 is connected. The carrier is a brush, which can be positioned on the surface 14 of a substrate 15.

As will be explained in more detail below, the device can be used to produce a layer 16, in which particles (not shown in more detail) are dispersed, on the substrate 15.

In order to produce the layer 16, the substrate 15 is placed in a collection container 17. Furthermore, the substrate 15 and the device 11 are connected to a voltage source, the substrate being connected as cathode. An electrolyte is fed from an electrolyte supply container 19 into the carrier 12. This electrolyte contains ions of the coating material, which will form the metallic matrix (not shown in more detail) of the layer 16. In addition, there is a conduit from a particle supply container 20, which contains a highly-concentrated suspension of the particles to be incorporated in the layer 16, into a second carrier 12a.

The conduit module 13 has a first conduit system 21 for the electrolyte and a second conduit system 22 having an issue point 22a for the particles. These are independent of one another, i.e. the first conduit system can be fed by the electrolyte supply container 19 and, independently thereof, the second conduit system 22 can be fed by the particle supply container 20. As the dispersing agent for the particles, it is possible, for example, to use a readily volatile liquid, which evaporates quickly after application of the particles, or else a liquid having the composition of the electrolyte.

In order to form a layer 16, the device 11 is then drawn over the surface 14 in the direction indicated (arrow). During this process, a continuous flow of particles and electrolyte is maintained, where the particles applied upstream of the carrier with a transfer surface 12b initially form a film 16a on the surface 14 and are incorporated in the subsequently applied layer 16.

The layer 16 is formed relatively quickly owing to the applied voltage, excess electrolyte mixed with the particles being collected in the collection container 17. A return conduit 23 leads from the latter to a separation device 24, where the particles are separated again from the electrolyte. The electrolyte, which then only contains insignificant quantities of particles, is returned back into the electrolyte supply container 19, and the particles, which are highly concentrated in the liquid of the electrolyte, are returned into the particle supply container 20, with it possibly also being necessary to change the dispersing agent. The coating process can then be continued with the recovered electrolyte and the recovered particles. In this case, it has to be taken into consideration that the material conversion taking place on the surface 14 during the formation of the layer 16 has to be compensated for (not shown).

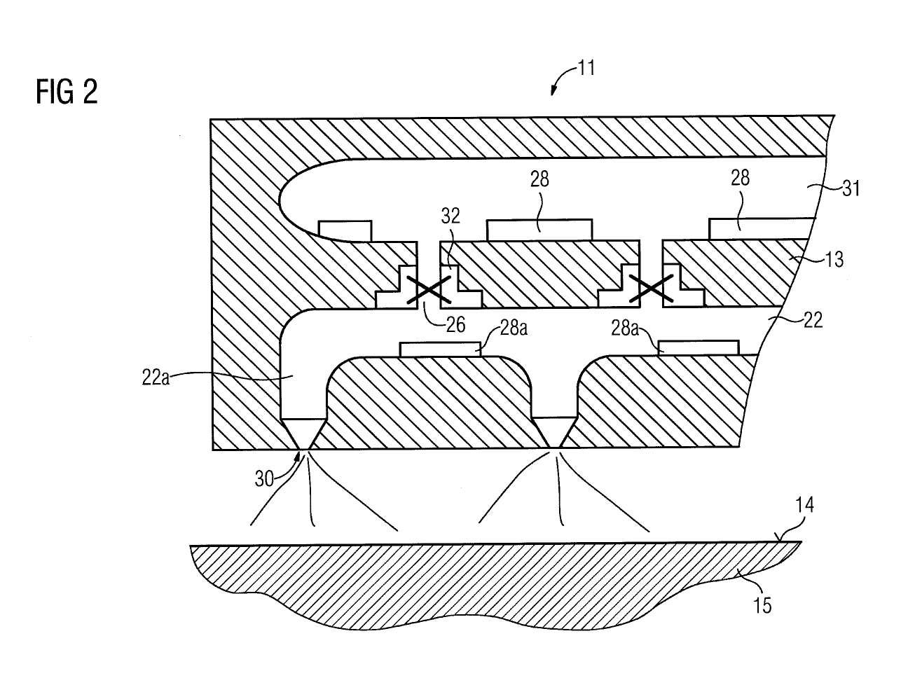

FIG. 2 shows a detail of a device, from which the interaction between the components of another conduit module 13 can be gathered. The conduit module has the second conduit system 22, which forms nozzles 30 adjoining the carrier 12 at the issue points 22a. The substrate 15 can be sprayed with the particle dispersion using the nozzles.

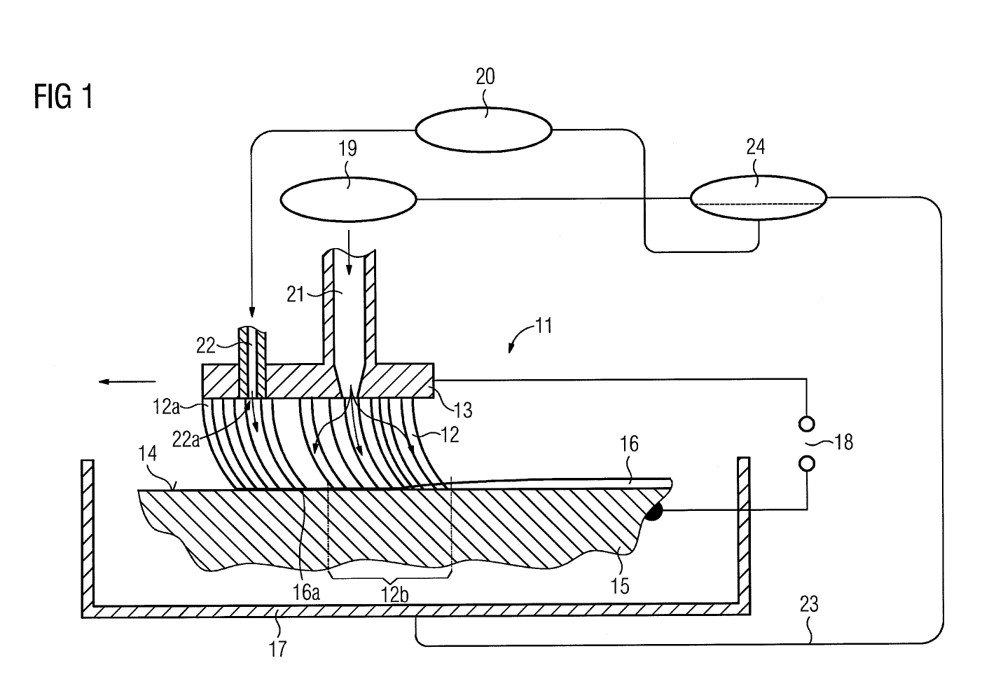

In contrast to the exemplary embodiment according to FIG. 1, a third conduit system 31 is arranged parallel to the second conduit system 22. Issue points 26 of the third conduit system 31 lead into the second conduit system 22. In this case, the electrolyte (or another dispersing agent) is therefore already mixed with the particles in the second conduit system. The path which the electrolyte dispersion thus produced still has to cover in the second conduit system 22 is short, and therefore neither separation nor agglomeration of the particles can occur.

The particles can preferably be conveyed in the third conduit system 31 as a powder. In order to prevent agglomeration, the generators 28 are arranged directly in the third conduit system 31. By way of example, these can be formed by piezo crystals. Furthermore, metering of the powder located in the second conduit system 22 can be simplified by the provision of metering valves 32 at the issue points 26. These can be designed as piezo valves. A very compact design of the conduit module can advantageously be implemented by using piezo technology. The paths in the second and third conduit systems (22, 31) can therefore be kept short, in order to preclude agglomeration of particles as far as the surface to be coated.

Not shown in FIG. 2, but equally conceivable, is a device 11 which does not have the second channel 22 shown in FIG. 2. The function of the second channel, which is that of applying the particles to the substrate 15, would then be taken on directly by the third channel 31 shown in FIG. 2, where the issue points 26 according to FIG. 2 would take on the function of the issue points 30. In this case, pulverulent particles would be metered directly by the metering valves 32 onto the surface 14 of the substrate 15. If the issue points are spaced apart by a sufficiently small extent, it is possible to cover the surface 14 on account of the adhesive forces of the particles, such that, in the subsequent electrolytic coating step, said particles can be incorporated in the layer which forms (not shown in FIG. 2).

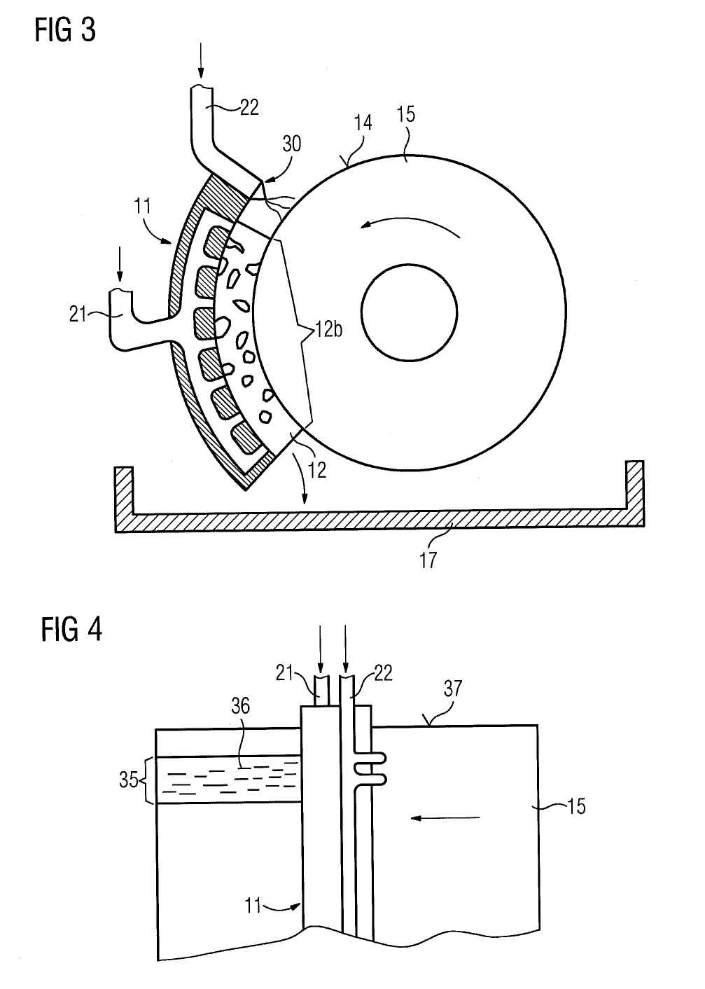

As shown in FIG. 3, the substrate 15 coated is a working roller for a rolling mill. In this case, it is expedient to incorporate particles which are much harder than the layer material in the coating. It is thereby possible, even with progressive removal of the coating, by virtue of the particles which protrude out of the surface 14 to produce a high surface roughness, which, in the case of cold rolling, is needed for transferring tensile forces from the roller to the sheet metal to be rolled.

In order to coat the working roller, the latter is rotated in the direction of the arrow indicated. The device 11 is moved toward the surface 14 of the working roller from the side, with a sponge being used as the carrier 12. The first conduit system 21 feeds the carrier with the coating electrolyte, with excess electrolyte being discharged into the collection container 17. In addition, a dispersion containing the particles to be incorporated is sprayed onto the surface 14 by the second conduit system 22 via the nozzle 30. Taking into account the direction of rotation of the working roller, it becomes clear, on account of the relative movement between the working roller and the carrier with the transfer surface 12b, that the dispersion with the particles is applied to the surface 14 before the coating by the electrolyte. The electrical interconnection of the device 11 and of the substrate 15 and also a channel system for feeding the conduit systems 21, 22 and also the connection of the collection container 17 can be gathered from FIG. 1, and can be implemented analogously. This also applies to the exemplary embodiment shown in FIG. 4.

As shown in FIG. 4, a roller, shown in a view from above, is coated as the substrate 15. FIG. 4 shows only one end, with the end which is not shown having the same form. The device 11 is positioned on the roller from above, it being possible for said device to be formed in a manner corresponding to the exemplary embodiment in FIG. 3. A difference in relation to the exemplary embodiment as shown in FIG. 3 only arises in the configuration of the second conduit system 22. Whereas, according to FIG. 3, the nozzles 30 spray the dispersion on over the entire width of the roller shown therein, and thus provide for the particles to be incorporated in all of the layer which is formed, the suspension is only applied in parts in FIG. 4. This forms a strip 35, in which CNTs 36, shown schematically, are incorporated as particles. This takes place in a region which lies close to the end face 37 of the roller and is intended to offer the highest possible wear resistance for a plain bearing arrangement of the roller. The rest of the roller is coated electrochemically without the incorporation of CNTs 36, in order for example to produce corrosion protection for the roller.

The procedure furthermore makes it possible for the CNTs 36 to obtain a preferred orientation in the strip 35 of the coating. Whereas the roller is rotated in the direction of the arrow indicated and the dispersion is applied to the surface of the roller upstream of the carrier (not shown in more detail), the subsequent relative movement between the carrier and the roller specifically has the effect that the CNTs 36 are oriented in the direction of movement, since the friction conditions between the CNTs 36 and the carrier are thereby optimized. The layer components produced in this way therefore have anisotropic properties, which, in the case of the exemplary embodiment shown in FIG. 4, have the effect, for example, that the degree of stiffening of the strip in the direction in which the latter is oriented turns out to be particularly great.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A process for electrochemically coating a particulate layer on a substrate, comprising:
feeding an electrolyte from a first conduit system, the electrolyte containing metallic ions and being fed to a brush plating carrier, the electrolyte having no particles or a concentration of particles reduced compared to a concentration sufficient to form the particulate layer;
treating the substrate with the carrier to apply the electrolyte and brush plate the substrate; and
before treating the substrate with the carrier, applying particles directly to the substrate using a second conduit system.

16. The process as claimed in claim 15, wherein the particles are supplied in the second conduit system as a dispersion.

17. The process as claimed in claim 15, wherein
the particles are supplied in the second conduit system as a dispersion, and
the dispersion is sprayed on or dripped on the substrate.

18. The process as claimed in claim 15, wherein the particles are conveyed in the second conduit system as a powder.

19. The process as claimed in claim 17, further comprising:
supplying energy to the second conduit system to prevent agglomeration of metallic the particles.

20. The process as claimed in claim 17, further comprising:
supplying ultrasonic energy to the second conduit system to prevent agglomeration of the particles.

21. The process as claimed in claim 15, wherein the particles are carbon nanotubes (CNTs) and/or boron nitride nanotubes (BNNTs).

22. The process as claimed in claim 21, wherein the carrier is guided over the substrate in a direction in which the CNTs and/or BNNTs are to be oriented on the substrate.

23. The process as claimed in claim 15, wherein
the substrate is a roller, and
the roller is rotated below the carrier about a center axis of rotation, for treating the substrate.

24. The process as claimed in claim 23, wherein
in addition to rotating the roller about the center axis of rotation, the roller is linearly moved relative to the carrier, in a direction of the center axis of rotation.

25. The process as claimed in claim 15, wherein that the particles are applied to only a portion of the substrate using the second conduit system, or the particles are applied in a quantity that varies locally over the substrate.

26. The process as claimed in claim 15, wherein
the layer is electrochemically coated on the substrate by forming a plurality of plies,
for each ply, the particles are applied to the substrate using the second conduit system before treating substrate with the carrier.

27. The process as claimed in claim 15, wherein the substrate is a working roller for rolling mills.

28. The process as claimed in claim 18, further comprising:
supplying ultrasonic energy to the second conduit system to prevent agglomeration of the particles.

29. A device to electrochemically coat a substrate by brush plating, comprising:
a carrier through which liquid passes and which has a transfer surface, to apply an electrolyte to the substrate;
a first conduit system to transfer the electrolyte, the first conduit system having outlets on the carrier; and
a second conduit system, which is fed independently of the first conduit system and which has an issue point arranged upstream of the transfer surface.

30. The device as claimed in claim 28, further comprising an ultrasonic generator engaged with the second conduit system.
